(19) United States
(12) Patent Application Publication
(10) Pub. No.: US 2014/0259911 A1
(43) Pub. Date: Sep. 18, 2014

(54) Low-Stress Plant Training

(71) Applicant: Samuel Joseph Davis, Kingston, MA (US)

(72) Inventor: Samuel Joseph Davis, Kingston, MA (US)

(21) Appl. No.: 14/156,889

(22) Filed: Jan. 16, 2014

Related U.S. Application Data
(60) Provisional application No. 61/802,608, filed on Mar. 16, 2013.

(51) Int. Cl. A01G 9/02

(52) U.S. Cl. CPC A01G 9/02
USPC 47/65.5

(57) ABSTRACT

Provided is a low stress plant training receptacle including a container having a closed bottom and an open top, the later having a rim, and a plurality of pairs of branch training means formed and positioned about the rim to accept and retain the lower plant branches of a plant placed in the container to spread the branches apart from one another substantially horizontally to stimulate the plant to produce interior growth, increasing the plant strength, diameter, canopy and yield.

### PRIORITY CLAIM

This application claims the priority of U.S. Provisional Application Ser. No. 61/802,608 filed 16 Mar. 2013.

### NOTICE OF FEDERALLY SUPPORTED RESEARCH

None.

### FIELD OF THE INVENTION

The invention is in the field of horticulture, more particularly, to plant husbandry, and most particularly to containers and methods for the training of plant foliage in increase canopy size and foliage and/or flower and fruit yield.

### BACKGROUND OF THE INVENTION

Each type of plant has its own “growth aspect”, which is the manner in which the plant naturally grows and the ultimate overall shape, i.e., morphology the plant takes as an adult. Determined by genetics, how the stems and leaves branch varies from species to species: some plants naturally spread; some naturally grow more or less vertically. See, Kaplan, The Science of Plant Morphology: Definition, History, and Role in Modern Biology, American Journal of Botany 88(10): 1711-41 (2001). Horticulturalists have been tying, pinning, clipping, wiring and even taping their plants' branches down for a long time to modify the plant's natural growth aspect, either for yield purposes or for decorative purposes. In the past, the usual training support for potted plants has taken the form of a dowel, stick, ruler, tape, string, or the like, one end of which is simply pushed into the soil within the planter the other end tied off to the plant. This is done to promote new inner growth that would not have gotten light before. This is a high stress form of training because it can damage the plant and cause excess stress—indeed damage to the plant in terms of reduced productivity and the risk of infections—by disturbing the root system, lacerating branches and tearing leaves which can lead to the formation of fungus and mold, a restriction of growth (like a tourniquet), and/or stunted growth causing damage to the crop and a reduction in yields. Stress for plants can be biotic or abiotic. While most biotic or abiotic stress on plants including temperature stress, drought stress, light stress or high salt create unfavorable growing conditions such as pruning, taping, wiring, tying or pinching. Low Stress training when applied appropriately and in moderation creates favorable growing conditions and is good for plants. Studies show that a better understanding of how plants cope with stress can contribute toward increasing crop yields more stress tolerant plants. See for example, Bruulsema “Stress Tolerance Boosts Crop Yields”, Potash & Phosphate Institute Agri-Briefs, Spring 1999, No. 1 retrievable from http://www.ipni.net/ppiweb/afbrief.nsf/5a4b8be72a35cd46852568d9001a18da/7f8 7037db0925c6485256904006d1de6!OpenDocument and Iowa State University, “Understanding How Crops Deal With Stress—Yield's Biggest Enemy, Science Daily (Apr. 26, 2011) retrievable from http://www.sciencedaily.com/releases/2011/04/110425173844.htm

Consequently, such supports proved less than satisfactory. Applying the old techniques mentioned above allows for the more likely possibility of damaging the plant, the soil, the yield, whether by application or restriction, because, the usual support is fixed in size length and position. Thus, unless unsightly long and oversized support stakes are initially used in anticipation of the fully grown plant, and the plant ties are constantly adjusted to shorten the length of the plant ties that attach the growing stems to the support stakes, it is necessary to disturb the soil and plant roots periodically to substitute successively longer supports to keep up with the plant growth. By having to adjust the length of the plant ties, there is the likelihood of varying the pressure on the growing stems. Maintaining a constant, even pressure on the growing stems rather than varying the pressure as the stems grows leads to more consistent, healthier plant growth.

Although various proposals have been made for the art of plant support in the field of plant husbandry, it appears that there has not been a plant support system invented specifically for low stress training of plants. Also, it appears that there has been no such plant support system devised or invented as a part of a plant receptacle/container.

By low stress training, I mean consistently stressing the plant but moderately stressing it less than high stress methods such as “pinching” as with bonsai. The term “low” as in “low stress” is a measurement of the intensity of the stress. It is resistance training for plants. These fabric elastic bands always have tension in them. The constant tension in these bands along with the natural growth of a plant (the plant is always growing outwards and the bands are always pulling inwards) equals resistance training. The outcome of constant resistance training for the plant is strength, strength at every point in the plant. Because of resistance training (just like for humans) strength is the result and therefore the plant can support its own weight in all cases and no further support systems are needed. That is why the LST Pot is more than a support system it is a piece of gym equipment for fruit and flower bearing plants. Low stress training results in initial plant growth that is substantially horizontal and more or less parallel to the ground. After the initial spreading of diameter of the plant through low stress training, the plant stems that have been spread extend vertically, which increases the overall diameter of the plant, increases the plant canopy and stimulates the interior growth of stems, foliage, buds and flowers. A larger, fuller plant is the result. Prior proposals for plant supports that do not intend to nor propose to provide for low stress training of plants specific to horizontal not linear growth of the canopy, and still have met with little or no success. For instance, U.S. Pat. No. 6,122,859 teaches the use of a knitted hosiery elastic loop for training, however it provides for a method of securing a plant limb to another limb or stake and does not train the branches to grow down and out horizontally to create an expanded and maximized canopy, but instead as illustrated in the patent, ties the elastic loop to a plant stake and allows for vertical growth; thus their elastic loop extends horizontally with a tie to support the plant growth vertically, whereas my invention of the low stress training pot, has the elastic loop attached to the pot, whereby the elastic loop extends straight up (vertically) to gently pull the plant limb or branch straight down and out, promoting horizontal not linear growth which maximizes the inner growth of the plant. When you tie the limb down, all of the branches off from that one limb are going to become tops and promote even more growth. Additionally, U.S. Pat. Nos. 291,569 and 3,447,263 teach the use of stakes which are extendable to compensate for plant growth, but such stakes are simply pushed into the soil and hence subject to dislodgment. Other proposals suggest continuously adjustable plant support but they are fixed, clipped, or fastened to promote vertical growth of plants, not horizontal maximization of plant canopies: U.S. Pat. Nos. 8,240,467, 7,856,754, 6,912,809, 7,380,371, 7,219,467, 6,925,754, and 4,099,299. Such patents fail to provide for low stress training methods for plants and horizontal growth of the canopy.

Accordingly, in spite of past attempts, the plant husbandry field has not succeeded in developing a simple, inexpensive, rugged, efficient, convenient, safe, soft, flexible, yet strong and sturdy combination planter receptacle and plant support device specifically for low stress training which increases canopy and yield of the plant.

### SUMMARY OF THE INVENTION

The present invention seeks to overcome difficulties associated with low stress training in the growth and development of plants in accordance with conventional techniques and in accordance with the proposals found in the patent literature and to provide a combined plant receptacle/container, plant support system, and method for plant growth in hydroponic and soil conditions and methods for personal scale growth and development of plants with substantially all of their foliage properly trained in a home environment or outside.

Accordingly, it is an objective of the present invention to provide an improved plant support and plant receptacle for use with potted plants.

Another objective of this invention is the provision of a device for low stress training for use with potted plants, the device including fabric elastic loops which are stitched around the top inside of the fabric bag evenly spaced.

Yet another object of this invention is to promote new inner growth that would not have gotten light naturally.

A still further object of this invention is an overall increase in canopy size due to the new inner growth, thereby increasing the overall yield of foliage, blossoms and/or fruit.

Still further, it is an object of this invention to provide a combined plant receptacle and plant support device which can be constructed inexpensively yet ruggedly and which is simple and convenient yet effective in use and does away with the need for a plant cage or other fruit and flower support devices, because the resistance training the LST pot provides makes the branches strong enough to support the fruit/flowers

The foregoing features and objects are provided by the low stress plant training receptacles of the invention which includes a container having a closed bottom and an open top, the later having a rim, and a plurality of pairs of branch training means formed and positioned about the rim to accept and retain the lower plant branches of a plant placed in the container to spread the branches apart from one another substantially horizontally to stimulate the plant to produce interior growth, increasing the plant diameter and canopy. The overall shape of the container is not critical: it may an open cube or cuboid, a cylinder or even a dodecahedron. Nor is the material used in the construction of the container critical: it may be made of plastic, fabric, ceramic, stone, wire mesh, although fabric is preferred. The plurality of pairs of branch training means are composed of a stretchable, elastic fabric material so as to be extendable with the plant as the plant grows. Materials that can be employed for this purpose include polyester, cotton, and rayon. Such stretchable elastic is known in the art and can be obtained from, for example, National Webbing Products, Co., Plainview N.Y. Advantageously, the pairs are composed of a material having differing lengths to accommodate upper and lower plant branches and are disposed in spaced-apart relation to each other so as to provide a variety of areas around the container where plant branches may be inserted in order to spread apart the lower branches of the plant and open up the aspect of the plant to allow for interior growth. Preferably, the pairs are composed of small and large loops the ends of which are secured to the top rim of container, for example by stitching, although other means of securement are well known in the art and may alternatively be employed. In another embodiment, branch training means are comprised of pairs of small and large unlooped lengths of material, one ends of which are secured about the container rim and the other ends of which are secured about the branches to be trained.

Optional handles attached to the upper opposed dies of the container may be included. The container may be formed of a variety of material—any suitable material known in the art may be used, for example recycled plastics, burlap, canvas, polyester, or plastic.

The plurality of pairs of branch training means should include between 4 and 8 pairs, preferably 4 pairs positioned about the container rim in symmetrical, space-apart manner. Each pair should be composed of two different lengths of stretchable material, preferably elastic. The actual lengths will vary with the size of the container and the type of plant being trained. A determination of the appropriate lengths is well within the level of skill in the art.

Yet additional objects and features of this invention will be apparent from the following specification and claims when considered in connection with the appended drawings.

### DESCRIPTION OF THE DRAWINGS

FIG. 1 is a front view of an untrained plant in a traditional, prior art, plant receptacle;

FIG. 2 is a front view of the low-stress plant training container of the invention;

FIG. 3 is a fragmentary enlarged view of one embodiment of the invention, showing a smaller elastic loop plant support of the invention of FIG. 1, secured by stitching to the top inside of the fabric pot;

FIG. 4 is a fragmentary enlarged view of the same embodiment of the invention shown in FIG. 2, showing a larger elastic loop plant support, secured by stitching to the top inside of the fabric pot of FIG. 1;

FIG. 5 is a fragmentary view, showing a fabric elastic loop training a branch of the plant to grow outward and allow new inner growth to become new main tops, the embodiment of FIG. 1; and

FIG. 6 is a perspective view of a plant having been low-stress trained by planting and growing the plant in the low-stress plant training container of the invention.

FIG. 7 is a fragmentary view illustrating a second embodiment of the branch training means of the invention.

### DETAILED DESCRIPTION

Referring first to FIG. 2, an embodiment of the invention is shown in which container 3 is preferably composed of a reusable material cubic in shape. While container 3 is illustrated as having a cubic shape, the shape of the container is not critical: a rounded container could also be employed for example. The container is formed with a bottom, 4, upwardly extending sides, 5, and an open top, generally 6. The sides terminate in a top rim, 7. Optional handles, 8, are provided to enable easy carrying of the container. Secured at or near top rim 7 of the container are a plurality of pairs of branch training means 10 and 11. Training means 10 and 11 are composed of an elastic fabric material so as to be extendable with the plant as the plant grows. As illustrated, branch training means 10 and 11 are shown as pairs of alternating small and large loops the ends of which are secured to top rim 7 of container 3. The pairs of alternating smaller and larger loops are disposed in spaced-apart relation to each other so as to provide a variety of areas around the container where plant branches may be inserted in order to spread apart the lower branches of the plant and open up the aspect of the plant to allow for interior growth. The container of the invention also has handles, 8, on either side 5 for easy transportation. Container 3 may be formed from a wide variety of materials. Exemplary are recycled plastics, canvas, polyester, and plastic.

Referring next to FIGS. 3 and 4, there are illustrated close up views of the fabric elastic loops comprising the branch training means 10 and 11 of the invention, as attached by stitching to the inside of the container near the upper rim. Alternatively, branch training means 10 and 11 may be secured in another manner to the container rim, for example by gluing, tying or by the use of grommets provided in the container rim to which the training means are attached. While shown attached by stitching to the inside of the container, training means 10 and 11 could be attached to the outside of the container as well. The critical feature is that the training means be formed of an elastic material so as to be able to stretch as the plant grows, and the pairs of training means having differing lengths so as to provide trainers for lower and higher branches. Because the training means are composed of a stretchable elastic material and are provided in pairs of differing lengths, the stress on the plant branches in training is minimized or lessened to a greater extent as compared to prior art training methods as illustrated in FIG. 1. The number of pairs may vary depending on the size of the container, the type of plant being trained and its usual growth pattern.

Referring now to FIG. 5, there is shown branch training means 10 and 11 training a branch of plant 12 to grow outward and allow new inner growth 13 to become new main tops and thereby forms a full plant canopy. It is important to note the differences between the training means of the invention and other support systems or plant trainers. With the invention provided herein, the range of movement and flexibility while sustaining full support of large heavy branches is significantly greater that with other methods, as will be obvious to those in the plant husbandry field, as is shown in FIG. 1, which depicts a plant 14 with foliage 15 and fruits and/or flowers 16 in common plant receptacle 20 with no training. By comparison, FIG. 6 depicts a plant 14 with foliage 15 and fruits and/or flowers 16 in the container of the invention, having lower branches 17, 18 being low-stress trained outward by means of their insertion into elastic loop pairs 10 and 11.

Training means 10 and 11 may be used with any one of a variety of planter sizes and/or with numerous types of plants. They are manually and selectively expandable to different lengths and heights above the plant container. In the illustrated embodiment, this expandable feature is provided by use of fabric elastic loops, to which are connected to plant branches 17 and 18. These sections may be made of a variety of materials, but it is presently preferred to use a relatively flexible fabric elastic, flat and soft, for instance knitting elastic ¼ inch diameter and bigger or smaller. Because it may be exposed to damp soil for long periods of time, at least the lower section preferably may be treated with a preservative of a type well known in the art.

As best illustrated in FIGS. 3 and 4, the ends of the fabric elastic loops are coupled together and fastened by means of stitching or sewing to the inside top rim of fabric container. Alternatively, branch training means 10 and 11 may be unlooped, straight pieces of elastic, stretchable, material, one end of which is secured to the container at or near the rim and the other end of which is secured to the plant branch requiring training, for example by means of an adjustable hook and loop or Velcro® stay. [See FIG. 7]

In use, a plant and growing medium for the plant is placed in the container and the growing medium tamped around the plant to provide s stable root growth environment. Thereafter, training means 10 and 11 are extended vertically over branches of plant branches 17 and 18 to train them outward and to start promoting new growth from inner nodes. These elastic fabric loop/plant supports do not depend upon the eventual growth of the plant, the plant support will extend on its own and will never need maintenance or adjustment (but this is possible if desired). The diameter of the plant depends upon the point (on the plants branches) at which loops are set. Loops may be reset as necessary to promote further horizontal growth.

In the event the device is to be used with a previously filled planter, the same procedure would be employed, as described above, except that the entire previously filled planter can be placed as is into the low-stress training container of the invention.

Watering of the potted plant is accomplished simply by pouring a quantity of water into the substrate/growing medium through the open upper top 6 of the container. In a preferred embodiment of the invention, the container is composed of a porous fabric material to allow aeration of the roots and proper ventilation. In the event of excess water, such excess will filter through the soil and through the sides and bottom of the container, and not drown the plant roots.

It is to be understood that although the preceding description and appended drawings are relatively detailed, they are for the purpose of illustrating and not limiting the present invention, the scope of which is defined by the following claims.

I claim:

1. A low stress plant training receptacle comprising a container having a closed bottom and an open top, the latter having a rim, and a plurality of pairs of branch training means formed and positioned about the rim to accept and retain the lower plant branches of a plant placed in the container to spread the branches apart from one another substantially horizontally to stimulate the plant to produce interior growth, increasing the plant diameter and canopy.

2. The plant training receptacle according to claim 1 wherein the plurality of pairs of branch training means are composed of a stretchable, elastic fabric material so as to be extendable with the plant as the plant grows.

3. The plant training receptacle according to claim 2 wherein the pairs are composed of a material having differing lengths to accommodate upper and lower plant branches.

4. The plant training receptacle according to claim 3 wherein the plurality of branch training means are disposed in spaced-apart relation to each other so as to provide a variety of areas around the container where plant branches may be inserted in order to spread apart the lower branches of the plant and open up the aspect of the plant to allow for interior growth.

5. The plant training receptacle according to claim 4 wherein the branch training means are comprised of pairs of small and large loops the ends of which are secured to the top rim of container.

6. The plant training receptacle according to claim 4 wherein the branch training means are comprised of pairs of small and large unlooped lengths of material, one ends of which are secured about the container rim and the other ends of which are secured about the branches to be trained.

7. The plant training receptacle according to claim 6 additionally comprising handles attached to the upper opposed side of the container.

8. The plant training receptacle according to claim 7 wherein the container is formed of a material selected from the group consisting of recycled plastics, canvas, polyester, and plastic.

9. The plant training receptacle according to claim 1 wherein the plurality of pairs of branch training means comprises between 4 and 8 pairs.

10. The plant training receptacle according to claim 9 wherein the plurality of pairs of branch training means comprises 4 pairs disposed and arranged in a symmetrical, space-apart manner about the container rim.

11. The plant training receptacle according to claim 10 wherein each pair is composed of two different lengths of looped elastic.
